(19) United States
(12) Patent Application Publication
(10) Pub. No.: US 2016/0339553 A1
(43) Pub. Date: Nov. 24, 2016

(54) MACHINE TOOL HAVING CLEANING UNIT

(71) Applicant: FANUC CORPORATION, MINAMITSURU-GUN (JP)

(72) Inventor: YASUYUKI NAKAZAWA, MINAMITSURU-GUN (JP)

(73) Assignee: FANUC CORPORATION, MINAMITSURU-GUN (JP)

(21) Appl. No.: 15/159,003

(22) Filed: May 19, 2016

(30) Foreign Application Priority Data
May 22, 2015 (JP) 2015-104783

(51) Int. Cl. B23Q 11/00; B23Q 11/12; B25J 11/00; B08B 9/093; B08B 5/02; B25J 19/02; B23Q 11/10; B08B 1/00

(52) U.S. Cl. CPC B23Q 11/0042; B23Q 11/10; B23Q 11/127; B08B 1/002; B08B 9/093; B08B 5/02; B25J 19/021; B25J 11/0085

(57) ABSTRACT

A machine tool includes a cooling fluid supplying part, e.g., a fan or a flow path, for supplying a cooling fluid which dissipates heat generated from the machine tool during operation. The cooling fluid supplying part is operable to supply the cooling fluid independently of a cooling action of a machining point of the machine tool. The machine tool also includes a cleaning part for cleaning the cooling fluid supplying part. The cooling fluid supplying part may be a fan or a flow path of the cooling fluid.

### BACKGROUND ART

1. Technical Field

The present invention relates to a machine tool having a cleaning unit.

2. Description of the Related Art

A cleaning unit for removing chips and the like, which are attached to a main axis or a workpiece during machining is known. A machine tool that is configured to perform a cleaning program stored in a control apparatus is known.

JP H11-033874 A discloses a machine tool in which cutting fluid supplied through a spindle for cooling a tool and air used for cleaning a tool holder can be supplied selectively.

JP S60-186154 A discloses a machine tool in which a cleaning tool and a cutting tool can be automatically exchanged, so as to clean an object to be machined while moving its main axis.

JP 2008-155324 A discloses a machine tool in which an appropriate cleaning path is automatically determined and a condition of cleaning can be set, so as to perform a cleaning process as necessary, depending on the type of machining.

Japanese Patent Application No. 2014-254437, which was filed by the applicant of the present application, but the contents of which have yet to be published, is directed to a main axis apparatus of a machine tool, in which a fluid is supplied within a cleaning path in order to remove coolant which has leaked from a rotational joint.

Japanese Patent Application No. 2014-209350, which was filed by the applicant of the present application, but the contents of which have yet to be published, is directed to an electric motor provided with a cleaning hole formed in a stator, housing, or fan cover. The electric motor is designed to introduce a compressed fluid through the cleaning hole, in order to remove foreign objects attached to a vent hole or fan of the electric motor.

In some cases, chips or dust generated during machining process may be attached to a cooling unit used for cooling the machine tool. In recent years, a water-soluble cutting fluid is being increasingly used in machine tools; thereby, increasing the likelihood that the cutting fluid in the form of mist may be attached to a portion relatively farther away from the machining point. For example, when foreign objects are attached to a blade of a fan, or when a flow path of a cooling fluid is blocked off by foreign objects, an expected cooling effect may not be achieved. Conventionally, in order to clean various cooling units used in a machine tool, it is necessary to clean the inside of the cooling units after removing a fan cover or a housing of the electric motor, thus requiring intensive workload for cleaning process. Therefore, there is a need for a machine tool which allows a cooling unit used in a machine tool to be easily cleaned.

### SUMMARY OF THE INVENTION

According to a first aspect of the present invention, there is provided a machine tool comprising a cooling fluid supplying part configured to supply a cooling fluid, wherein the cooling fluid supplying part is operable independently of a cooling action for cooling a machining point of the machine tool, and wherein the machine tool further comprises a cleaning part configured to clean the cooling fluid supplying part.

According to a second aspect of the present invention, there is provided a machine tool according to the first aspect, wherein the cooling fluid supplying part comprises a fan.

According to a third aspect of the present invention, there is provided a machine tool according to the first or second aspect, wherein the cooling fluid supplying part comprises a flow path of the cooling fluid.

According to a fourth aspect of the present invention, there is provided a machine tool according to any one of the first to third aspects, wherein the cleaning part is configured to supply a cleaning fluid to the cooling fluid supplying part.

According to a fifth aspect of the present invention, there is provided a machine tool according to the fourth aspect, wherein the cleaning fluid is supplied to the cooling fluid supplying part through a pipe, and wherein the cooling fluid supplying part has a structure configured to receive the pipe.

According to a sixth aspect of the present invention, there is provided a machine tool according to the fourth or fifth aspect, wherein the machine tool comprises a plurality of cooling fluid supplying parts provided in positions distant from each other, and wherein the cleaning fluid supplied from the cleaning part is supplied to the plurality of cooling fluid supplying parts through a plurality of pipes in communication with each other.

According to a seventh aspect of the present invention, there is provided a machine tool according to any one of the first to sixth aspects, wherein the machine tool further comprises a robot, and wherein the cleaning part is attached to the robot.

According to an eighth aspect of the present invention, there is provided a machine tool according to the seventh aspect, wherein the robot is capable of exchanging a workpiece to be machined by the machine tool.

According to a ninth aspect of the present invention, there is provided a machine tool according to any one of the first to eighth aspects, wherein the machine tool further comprises a control apparatus configured to control the cleaning part, and wherein the control apparatus is configured to control at least one of the content of a cleaning process performed by the cleaning part or a duration of the cleaning process.

According to a tenth aspect of the present invention, there is provided a machine tool according to the ninth aspect, wherein the cleaning part is configured to supply a cleaning fluid to the cooling fluid supplying part, and wherein the control apparatus is configured to control pressure and flow rate of the cleaning fluid, a start time at which supply of the cleaning fluid is initiated, and a time period for which the cleaning fluid is supplied.

According to an eleventh aspect of the present invention, there is provided a machine tool according to the tenth aspect, wherein at least one of the machine tool and the robot further comprises a vision sensor, and wherein the control apparatus is configured to determine the start time, based on information detected by the vision sensor.

These and other objects, features and advantages of the present invention will become more apparent in light of the detailed description of exemplary embodiments thereof as illustrated in the drawings.

### BRIEF DESCRIPTION OF THE DRAWINGS

FIG. 1 is a perspective view illustrating a machine tool according to one embodiment.

FIG. 2 is a side view illustrating an electric motor used in a machine tool.

FIG. 3A is a perspective view illustrating an amplifier used in a machine tool.

FIG. 3B is a view from the opposite side of the amplifier shown in FIG. 3A.

FIG. 4 shows a robot used with a machine tool.

### DETAILED DESCRIPTION

Embodiments of the present invention will be described with reference to the accompanying drawings. Constituent elements of the illustrated embodiments may be modified in size in relation to one another as necessary, in order to facilitate understanding of the present invention. The same or corresponding constituent elements will be designated with the same referential signs.

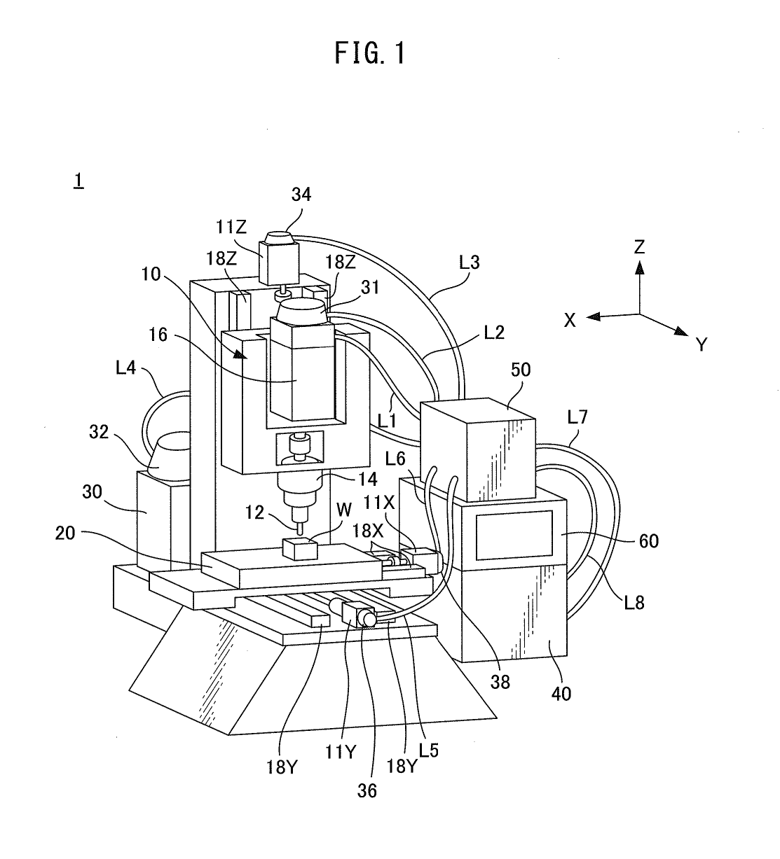

FIG. 1 is a perspective view illustrating a machine tool 1 according to one embodiment. The machine tool 1 includes a main axis apparatus 10, a table 20 on which a workpiece W is mounted, an amplifier 40 for supplying electric power to driving units of the main axis apparatus 10 and the table 20, a cleaning fluid supplying apparatus 50 for supplying a cleaning fluid, and a control apparatus 60 for controlling the amplifier 40 and the cleaning fluid supplying apparatus 50.

The main axis apparatus 10 includes a main axis 14 provided with a tool 12 at its tip end, a main axis motor 16 for rotating the main axis 14 around a Z-axis line. The main axis apparatus 10 also includes an electric motor 11z (hereinafter may be referred to as “the Z-axis motor 11Z”) for moving the main axis 14 in a Z-axis direction. The main axis 14 moves along a pair of guides 18Z extending in the Z-axis direction. The main axis motor 16 is provided with a fan 31 used for dissipating heat generated from the main axis motor 16.

The table 20 is driven along a pair of guides 18X extending in an X-axis direction by an electric motor 11X (hereinafter may be referred to as “the X-axis motor 11X”). The table 20 is also driven along a pair of guides 18Y extending in a Y-axis direction by an electric motor 11Y (hereinafter may be referred to as “the Y-axis motor 11Y”). In this way, the tool 12 and the workpiece W can be moved relative to each other in the X-axis direction, Y-axis direction, and Z-axis direction, respectively.

The electric motors 11X, 11Y, and 11Z are provided with fans 38, 36, and 34, respectively. The fans 38, 36, and 34 generate air stream, in order to dissipate heat generated from the electric motors 11X, 11Y, and 11Z.

The main axis 14 is a hollow axis inside which a supply path of coolant is formed. The machine tool 1 performs desired machining process, such as cutting, by rotating the main axis 14 while moving the tool 12 relative to the workpiece W in the X-axis direction, the Y-axis direction, and the Z-axis direction. During the machining process, a coolant is injected through the main axis 14, in order to cool a machining point, or in other words, a contact point between the tool 12 and the workpiece W. This type of cooling for the machining point is referred to as “center through coolant,” and employed in order to improve machining accuracy of the workpiece W, and extend the life of the tool.

The coolant is adapted to be supplied to the main axis 14 from a coolant tank through a pump, both of which are not illustrated in the drawings. The pump is driven by an electric motor 30 (hereinafter may be referred to as “the pump motor 30”) to pressurize coolant contained in the coolant tank. A fan 32 is attached to the pump motor 30 in order to dissipate heat generated from the pump motor 30.

The cleaning fluid supplying apparatus 50 supplies a cleaning fluid to the main axis motor 16, the pump motor 30, and other motors. The cleaning fluid may be pressurized air, for example. The cleaning fluid supplying apparatus 50 has pipes L1 to L8 extending therefrom up to target sites to be cleaned, in order to supply the cleaning fluid.

More specifically, the pipes L1 to L8 extend up to various cooling fluid supplying parts which are adapted to supply cooling fluid, independently of the cooling action of the machining point of the machine tool 1. As described above, the coolant is supplied to the machining point of the machine tool 1 by way of the center through coolant. Due to this, the machining point is cooled during machining process.

In the present specification, when a certain process or action is realized “independently of the cooling action of the machining point,” the cooling of the machining point can be performed without realizing the above-mentioned process or action. For example, since the fan 31 for cooling the main axis motor 16 is used to cool the main axis motor 16, the fan 31 can operate independently of the cooling action of the machining point. Likewise, any of the fan 38 for cooling the X-axis motor 11X, the fan 36 for cooling the Y-axis motor 11Y, and the fan 34 for cooling the Z-axis motor 11Z can operate independently of the cooling action of the machining point. The fan 32 for cooling the pump motor 30 is expected to be activated when the coolant is supplied, but also operate, depending on the state of heat generation from the pump motor 30. Therefore, the fan 32 is also considered as operable “independently of the cooling action of the machining point.”

On the other hand, the supply path of the coolant which is supplied to the machining point through a through hole of the main axis 14 (e.g., the internal flow path of the main axis 14 and the internal flow path of the rotational joint, etc.) is intended to be always used when the coolant is supplied to cool the machining point, and therefore not considered as operable “independently of the cooling action of the machining point.”

Referring to FIG. 1 again, the control apparatus 60 is a digital computer for controlling the machine tool 1, and configured to output a current command to the amplifier 40. According to one embodiment, the control apparatus 60 may be programmed so as to output control commands to the cleaning fluid supplying apparatus 50, in order to control the pressure and flow rate of the cleaning fluid, a start time at which the supply of the cleaning fluid is initiated, a time period for which the cleaning fluid is supplied (a time period for which the supplying process is continued), and the like. According to one embodiment, the control apparatus 60 may be programmed so as to perform the cleaning process periodically.

The pipe L1 is connected to a flow path of the cooling fluid for cooling the main axis motor 16. The pipe L2 is connected to the fan 31 of the main axis motor 16.

The pipe L3 is connected to the fan 34 of the Z-axis motor 11Z. The pipe L4 is connected to the fan 32 of the pump motor 30. The pipe L5 is connected to the fan 36 of the Y-axis motor 11Y. The pipe L6 is connected to the fan 38 of the X-axis motor 11X.

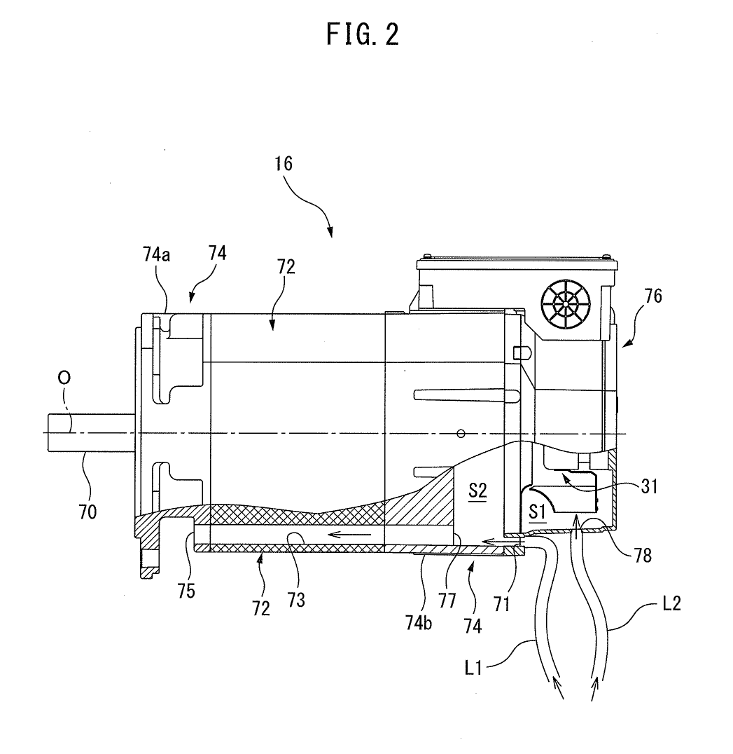

FIG. 2 shows an electric motor used for the machine tool 1. The main axis motor 16 is described herein by way of example, but it should be noted that other electric motors, such as the X-axis motor 11X and the pump motor 30, have the same configuration as the main axis motor 16, and the following explanation with reference to FIG. 2 can apply thereto in the same way.

The main axis motor 16 includes a rotational axis 70, a stator 72, a housing 74, a fan 31, and a fan cover 76. The rotational axis 70 is attached to the housing 74 via a bearing, which is not illustrated in the drawing, so as to be rotatable relative to the stator 72 around a rotational axis line O. The stator 72 may be, for example, formed from electromagnetic steel plates stacked in a direction of the rotational axis line O, so as to surround the rotational axis 70.

The stator 72 is supported by the housing 74. The housing 74 has a front housing 74a provided on the side of the output axis, and a rear housing 74b provided on the opposite side (the side on which the fan 31 is provided).

The fan 31 is adapted to generate air stream within the internal space S1 of the fan cover 76, by rotating a rotational body having a plurality of blades. The fan 31 is housed in the fan cover 76 which is fixed to the rear housing 74b.

The stator 72 and the housing 74 are formed with a flow path 73 of air for cooling the stator 72. The flow path 73 extends along the rotational axis line O through a first opening 71 formed in the fan cover 76, a second opening 77 formed in the rear housing 74b, and a third opening 75 formed in the front housing 74a. The first opening 71 is in communication with the internal space S2 of the rear housing 74b. The internal space S2 is in communication with the internal space S1 of the fan cover 76.

The fan cover 76 is formed with a fan hole 78 in communication with the internal space S1. A tip end of the pipe L2 extending from the cleaning fluid supplying apparatus 50 is fixed to the fan hole 78. The cleaning fluid supplied through the pipe L2 is introduced to the fan 31 through the fan hole 78, as indicated by the arrow in FIG. 2.

The cleaning fluid entering toward the fan 31 through the fan hole 78 is adapted to remove foreign objects attached to the fan 31, flows through the internal space S1 of the fan cover 76, the internal space S2 of the rear housing 74b, and then the flow path 73, and is discharged from the main axis motor 16. Accordingly, the cleaning fluid supplied to clean the fan 31 can also remove foreign objects attached to the flow path 73.

A tip end of the pipe L1 extending from the cleaning fluid supplying apparatus 50 is fixed to the first opening 71 in communication with the flow path 73. The cleaning fluid supplied through the pipe L1 is introduced toward the second opening 77 through the first opening 71, as indicated by the arrow in FIG. 2. In this way, foreign objects attached to the fluid path 73 can be removed by the cleaning fluid introduced through the first opening 71.

Referring again to FIG. 1, the pipes L7 and L8 are attached to the amplifier 40 so as to supply the cleaning fluid to a fan 42 and a heat sink 44 for cooling the amplifier 40.

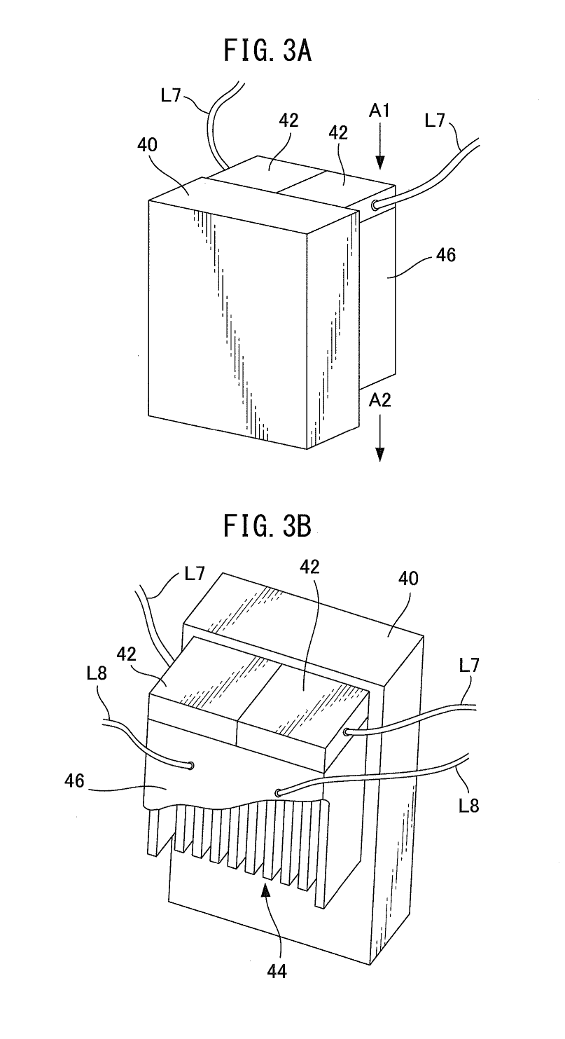

FIG. 3A is a perspective view illustrating the amplifier 40 used in the machine tool 1 from the front side. FIG. 3B is a perspective view illustrating the amplifier 40 from the opposite side of FIG. 3A. The fan 42 generates air stream passing through a flow path inside the heat sink 44, as indicated by the arrows A1 and A2.

With reference to FIGS. 3A and 3B together, the pipe L7 is attached so as to supply the cleaning fluid to the fan 42 for cooling the amplifier 40.

The pipe L8 is attached to the cover 46 of the heat sink 44 so as to supply the cleaning fluid to the heat sink 44 for cooling the amplifier 40. In FIG. 3B, a part of the cover 46 is removed such that the heat sink 44 is visible.

The cleaning fluid supplied through the pipe L7 is introduced to the fan 42. The cleaning fluid supplied through the pipe L8 is introduced toward the heat sink 44.

According to the present embodiment, the machine tool 1 is configured such that the cleaning fluid is supplied to the cooling fluid supplying part which is operable independently of the cooling action of the machining point. In this way, foreign objects, which are attached to the cooling fluid supplying part or the like, such as coolant, chips, dust, can be forcibly removed. Accordingly, the cooling effect for cooling the machine tool 1 can be prevented from being decreased due to the foreign objects attached to the cooling fluid supplying part. As a result, the machine tool 1 can be prevented from being damaged due to excessive heat, and the operation efficiency can be prevented from being decreased.

Also in the present embodiment, each of the cooling fluid supplying part is cleaned by the cleaning fluid supplied through the pipes L1 to L8. Therefore, the required cleaning process can be completed without the fan cover 76, the cover 46 of the heat sink, and the housing 74 being detached, resulting in the increase in efficiency of the cleaning process.

Also in the present embodiment, the control apparatus 60 controls the duration of the cleaning process and the supply pressure of the cleaning fluid, and the like. Therefore, the cleaning process may be automated so as to be performed periodically. It may also be possible to preferentially or selectively clean a certain portion where foreign objects tend to be attached. For example, the duration of the cleaning process may be set to be relatively longer for the fan 31 of the main axis motor 16 which is provided closer to the tool 12.

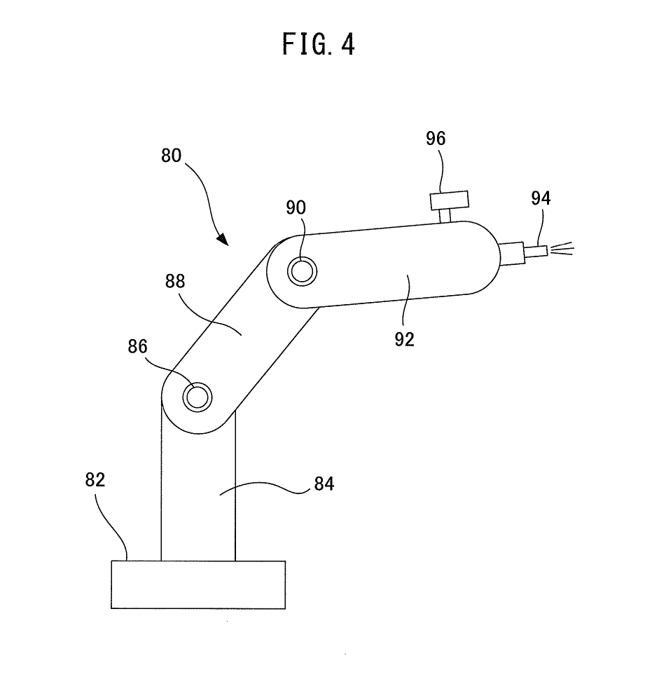

According to another embodiment, the cleaning fluid may be supplied from a nozzle attached to a tip end of the robot. FIG. 4 shows a robot 80 used with the machine tool 1. In one embodiment, the robot 80 may be a robot used to exchange the tool 12 of the machine tool 1 as necessary.

The robot 80 includes a base 72 fixed to an installation surface, a body 84 rotatable relative to the base 82, a lower arm 88 attached to the body 84 so as to be rotatable around a first rotational axis 86, and an upper arm 92 attached to the lower arm so as to be rotatable around a second rotational axis 90.

A nozzle 94 for supplying a cleaning fluid is attached to the tip end of the upper arm 92. The nozzle 94 is connected to a fluid tank and a pump, which are not illustrated in the drawing, such that the cleaning fluid can be supplied through the nozzle 94.

A vision sensor 96 is attached to the upper arm 92 of the robot 80. The vision sensor 96 captures an image of the cooling fluid supplying part of the machine tool 1 in order to detect a contamination level of the cooling fluid supplying part. The vision sensor 96 may also be directly attached to the cooling fluid supplying part of the machine tool 1. The image information obtained by the vision sensor 96 is processed by an image processing apparatus which is incorporated in the control apparatus 60. Alternatively, the machine tool 1 may be provided with an image processing apparatus separately from the control apparatus 60.

The control apparatus 60 may be programmed to modify the duration of the cleaning process or the pressure of the cleaning fluid, depending on the contamination level of the cooling fluid supplying part of the machine tool 1, which is obtained by the vision sensor 96. This allows the cleaning process to be performed flexibly, depending on the actual contamination level.

In accordance with the embodiment shown in FIG. 1, the machining apparatus configured to machine a workpiece W by moving the main axis apparatus 10 and the table 20 relative to each other has been described. However, the present invention is not limited to the particular type of machine tool. Rather, the present invention can be applied to any type of machine tool as long as the machine tool is provided with a fan, a heat sink or other cooling fluid supplying parts.

As explained above with reference to the illustrated embodiment, the term “cooling fluid supplying part” used herein may be construed as including not only a forcible cooling unit, such as a fan, but also a flow path of a cooling fluid or a heat sink.

The present invention is not limited to a particular type in which airstream is generated to cool a machine tool, but may also be used in order to clean a liquid cooling unit.

According to one embodiment, at least two or more of the pipes L1 to L8 may branch off from a common pipe which extends from the cleaning fluid supplying apparatus 50. In this case, different portions can be cleaned simultaneously, thereby increasing the efficiency of cleaning.

Although the embodiment in which a cleaning fluid is supplied to remove foreign objects has been described, it may be possible to use a cleaning tool, e.g., a brush, attached to a robot, to remove foreign objects through direct contact between the cleaning tool and a portion to be cleaned.

### Effect of the Invention

According to the machine tool of the present invention, a cleaning part is provided to clean the cooling fluid supplying part for supplying a cooing fluid. Therefore, the cooling effect of the machine tool by the cooling fluid supplying part can be prevented from being reduced due to attachment of foreign objects. This also prevents the machine tool from being damaged due to excessive heat, or the operation efficiency from being decreased.

Although various embodiments and variants of the present invention have been described above, it is apparent for a person skilled in the art that the intended functions and effects can also be realized by other embodiments and variants. In particular, it is possible to omit or replace a constituent element of the embodiments and variants, or additionally provide a known means, without departing from the scope of the present invention. Further, it is apparent for a person skilled in the art that the present invention can be implemented by any combination of features of the embodiments either explicitly or implicitly disclosed herein.

What is claimed is:

1. A machine tool comprising a cooling fluid supplying part configured to supply a cooling fluid, wherein the cooling fluid supplying part is operable independently of a cooling action for cooling a machining point of the machine tool, and wherein the machine tool further comprises a cleaning part configured to clean the cooling fluid supplying part.

2. The machine tool according to claim 1, wherein the cooling fluid supplying part comprises a fan.

3. The machine tool according to claim 1, wherein the cooling fluid supplying part comprises a flow path of the cooling fluid.

4. The machine tool according to claim 1, wherein the cleaning part is configured to supply a cleaning fluid to the cooling fluid supplying part.

5. The machine tool according to claim 4, wherein the cleaning fluid is supplied to the cooling fluid supplying part through a pipe, and wherein the cooling fluid supplying part has a structure configured to receive the pipe.

6. The machine tool according to claim 4, wherein the machine tool comprises a plurality of cooling fluid supplying parts provided in positions distant from each other, and wherein the cleaning fluid supplied from the cleaning part is supplied to the plurality of cooling fluid supplying parts through a plurality of pipes in communication with each other.

7. The machine tool according to claim 1, wherein the machine tool further comprises a robot, and wherein the cleaning part is attached to the robot.

8. The machine tool according to claim 7, wherein the robot is capable of exchanging a workpiece to be machined by the machine tool.

9. The machine tool according to claim 1, wherein the machine tool further comprises a control apparatus configured to control the cleaning part, and wherein the control apparatus is configured to control at least one of the content of a cleaning process performed by the cleaning part or a duration of the cleaning process.

10. The machine tool according to claim 9, wherein the cleaning part is configured to supply a cleaning fluid to the cooling fluid supplying part, and wherein the control apparatus is configured to control pressure and flow rate of the cleaning fluid, a start time at which supply of the cleaning fluid is initiated, and a time period for which the cleaning fluid is supplied.

11. The machine tool according to claim 10, wherein at least one of the machine tool and the robot further comprises a vision sensor, and wherein the control apparatus is configured to determine the start time, based on information detected by the vision sensor.
